(19) United States
(12) Patent Application Publication
(10) Pub. No.: US 2023/0121995 A1
(43) Pub. Date: Apr. 20, 2023

(54) INTEGRATED SURFACE ACOUSTIC WAVE BIOSENSOR SYSTEM FOR POINT-OF-CARE-DIAGNOSTIC USE

(71) Applicant: AVIANA MOLECULAR TECHNOLOGIES, LLC, Orlando, FL (US)

(72) Inventors: Thomas Ostertag, Geretsried (DE); Anand Tushar Singh, Winter Park, FL (US)

(73) Assignee: AVIANA MOLECULAR TECHNOLOGIES, LLC, Orlando, FL (US)

(21) Appl. No.: 17/963,621

(22) Filed: Oct. 11, 2022

Related U.S. Application Data
(60) Provisional application No. 63/254,806, filed on Oct. 12, 2021.

(51) Int. Cl. G01N 29/02; G01N 29/24

(52) U.S. Cl. CPC G01N 29/022; G01N 29/2437; G01N 2291/0423; G01N 2291/02466

(57) ABSTRACT

A system and method for diagnosing infectious disease using integrated surface acoustic wave sensor technology includes an efficient, low-cost integrated surface acoustic wave (SAW) biosensor based system for point-of-care diagnostics. The SAW biosensor, sample receiving portions and interface portions of the system are configured on a disposable cartridge.

### FIELD OF THE DISCLOSURE

The present disclosure relates to methods and apparatus for identifying chemicals, toxins, gaseous materials and/or biomarkers related to disease or wellness or environmental issues including for instance, infectious disease (e.g., bacterial, fungal, parasitic infections, viral infections, etc.), chemotoxins, biotoxins that can cause illness or affect the well-being of humans and animals of interest. More particularly, the disclosure relates to integrated (both surface and bulk) acoustic wave sensor systems for detection of infectious agents such as bacteria or viruses. Furthermore, gaseous materials detection which could be used to determine alternative energy sources such as hydrogen is also included.

### BACKGROUND OF THE DISCLOSURE

There has been a long felt need for an efficient and accurate point of care diagnostic system and method for detecting infectious diseases, wellness markers and other biological or gaseous markers of interest is needed that are more accurate, portable and rapid in areas where such encounters happen. This can include both human and animal diagnostics for companion and feed animals, research related applications and food safety applications.

Currently available diagnostic systems utilize either optical (light) or electrochemical methods of analysis. However, the use of acoustic based analysis of similar conditions (all methods of acoustic analysis and in particular, surface and bulk acoustic waves) has previously been proposed but not implemented in various biosensor designs for use in portable and point of care diagnostic systems and detectors. In particular, in this application, an acoustic wave knows as Surface acoustic wave (SAW) sensors which operate on the principal of passive wireless sensing mass/viscosity using piezoelectricity as a sensing agent is described followed by an electronic detection parameters when changes to the acoustic wave is conveyed as a change in electronic measures. Piezoelectricity is a phenomenon displayed in certain crystals, such as quartz and lithium tantalite, where voltage generation is induced by mechanical stress. Interestingly, the reverse is also true wherein application of voltage will induce a mechanical deformation or stress. The ability of the piezoelectric crystals to undergo atomic vibration in the presence of an electrically generated radio frequency input presents the ability of crystals to function as sensors. SAW sensors are used in the detection of changes in mass, elasticity, conductivity, and dielectric properties derived from mechanical or electrical variations. SAW sensors also employ the piezoelectric effect to excite acoustic waves electrically at an input transducer and to receive the waves at the output transducer. In our case, in particular, we also employ a reflector as part of this pathway for the electronic acoustic wave.

### SUMMARY

The present disclosure describes an integrated and mutually dependent system and method for diagnosing infectious disease, such as bacterial, fungal, parasitic infections, viral infections, and infectious disease caused by viruses, such as SARS-CoV-2, for example, and many non-infectious biomarkers such as hormones, proteins etc. amongst many others of biological interest, including determining real time biological binding activity detections such as real time binding of affinity agents such as antigen antibody binding dynamics under various biological conditions as described in the application. The disclosed system employs integrated surface acoustic wave sensor technology in an efficient, low-cost integrated surface acoustic wave (SAW) biosensor based system for point-of-care diagnostic use that is able to reliably identify biological samples having specific infectious agents along with an enhanced detection system and the integrated connectors and software to activate such a system and to provide the analytical tools and user interface for accurate biodetection.

Aspects of the present disclosure include an integrated surface acoustic wave biosensor system for point-of-care diagnostic. The system includes a disposable cartridge component and a reusable reader which includes a novel contact region. It also includes the workings of a reuseable reader. According to aspects of the present disclosure, the disposable cartridge component includes a sample well for addition of a biological sample, a saline-saturated absorbent pad or a buffer can containing a buffer of choice, an integrated surface acoustic wave (SAW) biosensor, a printed circuit board (PCB) coupled to the SAW biosensor, and a gasket. In addition, an off cartridge reagent disposable system will form an integral part of the system. The disposable cartridge also includes a cassette for housing the sample well, the saline-saturated or saline containing compression pad or can, the SAW biosensor, the printed circuit board and gaskets. Out of cartridge systems for sample processing may also be included, as are reagent tubes that contain a number of reagents such as gold nanoparticles and buffers. According to aspects of the present disclosure, the reusable reader contact region includes a mating capacitive coupled PCB configured to couple to the capacitive coupled PCB to the SAW biosensor in the disposable cartridge component, and a connector configured for securing a cable for transmitting data from the mating capacitive coupled PCB to the reusable reader. An illustrative embodiment of the disclosed system may also include a dielectric material, such as Kapton TM tape coupled to the mating capacitive coupled PCB of the reusable reader contact region.

Another aspect of the present disclosure provides a disposable cartridge component of an integrated surface acoustic wave biosensor system for point-of-care diagnostic use. The disposable cartridge component includes a sample well for addition of a biological sample, a saline-saturated absorbent pad, an integrated surface acoustic wave (SAW) biosensor, a printed circuit board (PCB) coupled to the SAW biosensor, a gasket; and a cassette for housing the sample well, the saline-saturated compression pad, the SAW biosensor, the printed circuit board, the gasket. The disposable cartridge may also include a sample cap with an air vent to secure the sample well, for example.

In an illustrative embodiment, the saline-saturated absorbent pad is compressed with a saline cap comprising a spring. In another illustrative embodiment, the SAW biosensor includes a sample channel and one or more reference channels. In another illustrative embodiment, the SAW biosensor includes a piezoelectric crystal base, such as a lithium tantalite crystal base. In another illustrative embodiment, the SAW biosensor further comprises capacitive coupled contact pads.

Another aspect of the present disclosure provides a disposable cartridge component of an integrated surface acoustic wave biosensor system for point-of-care diagnostic use. The disposable cartridge component includes a sample well for addition of a biological sample, a saline well comprising saline for coupling with the sample well, a cassette body structure comprising an integrated surface acoustic wave (SAW) biosensor, a printed circuit board (PCB) capacitively coupled to the SAW biosensor for, and a gasket, a docking station on the cassette body structure for coupling with the saline well and sample well, and an absorbent wicking pad.

In an illustrative embodiment, the sample well and the saline comprises foils to secure the biological sample and the saline. In another illustrative embodiment, the cassette body structure comprises at least one saline pinch valve and at least one sample channel valve. In another illustrative embodiment, the saline pinch valve is opened when the saline well is coupled to the docking station. In another illustrative embodiment, the absorbent wicking pad pulls saline at a rate of 5µl/min. In another illustrative embodiment, the gasket is made of polydimethylsiloxane (PDMS). In another illustrative embodiment, the SAW biosensor comprises a sample channel and a reference channel.

Another aspect of the present disclosure provides a disposable cartridge component of an integrated surface acoustic wave biosensor system for point-of-care diagnostic use. The disposable cartridge component includes a sample well for addition of a biological sample, a reusable flexible hourglass with grains, a timer holder for holding the flexible hourglass with grains, a flexible sample cap for securing the sample well, a saline blister pack comprising saline, and a cassette body comprising an integrated surface acoustic wave (SAW) biosensor, a printed circuit board (PCB) coupled to the SAW biosensor for, and a gasket. The biological sample may require processing prior to its addition to the sample well on the disposable cartridge. Materials for off cartridge sample preparation includes, but is not limited to, reagent tubes containing buffer solutions, reagents, such as gold nanoparticles, which may be lyophilized or in solution, syringes, and syringe filters.

In an illustrative embodiment, the disposable cartridge component may also include a waste well with an air vent for the displaced biological sample and saline. In another illustrative embodiment, the SAW biosensor is enclosed with an overmolded thermoplastic elastomer. In another illustrative embodiment, the SAW biosensor includes a sample channel and a reference channel.

Other iterations include a container containing buffer which can be released into the fluidics and a method for advancing the appropriate fluidics at the right time of testing by using a hand advanced crank or an automatic moving processes to move the fluid at the correct fluid volume / minute over the sensor as determined by external studies.

Another aspect of the present disclosure provides a method for detecting a target analyte in a biological sample using an integrated surface acoustic wave biosensor system. According to aspects of the present disclosure, the method includes steps of providing a disposable cartridge component of the integrated surface acoustic wave biosensor system, providing the biological sample into a sample well of the disposable cartridge component, applying surface acoustic waves to the sample in the sample well to generate a characteristic electrical signal of the biological sample, and detecting the target analyte based on the characteristic electrical signal. According to this aspect of the present disclosure, the disposable cartridge component includes a sample well for addition of the biological sample, a saline-saturated absorbent pad, an integrated surface acoustic wave (SAW) biosensor, a printed circuit board (PCB) coupled to the SAW biosensor, a gasket, and a cassette for housing the sample well, the saline-saturated compression pad, the SAW biosensor, the printed circuit board, the gasket.

### BRIEF DESCRIPTION OF THE DRAWINGS

The present disclosure will now be described more fully hereinafter with reference to the accompanying drawings, in which preferred embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout. Other objects, features and advantages of the present disclosure will become apparent from the detailed description of the disclosure, which follows when considered in light of the accompanying drawings in which:

FIG. 1 presents an exemplary design of a MHz SAW sensor.

FIG. 2A shows an exemplary design of a MHz SAW sensor, which has been modified for capacitive coupling with metal contact pads.

FIG. 2B shows an exemplary design of a MHz SAW sensor, which has been modified for capacitive coupling with metal contact pads and a third channel for temperature compensation.

FIG. 2C shows an exemplary design of a SAW sensor, which has been redesigned for capacitive coupling with circular metal contact pads to improve the X Y positioning tolerance on the capacitive coupled PCB.

FIG. 3A presents an exemplary design of a top surface of a mating capacitive printed circuit board (PCB) onto which a SAW sensor is placed.

FIG. 3B presents an exemplary design of a bottom surface of a mating capacitive printed circuit board (PCB) introduced in FIG. 3A, comprising a sub miniature push-on (SMP) connector connected to a reader unit via a subminiature version A (SMA) cable.

FIG. 3C presents a bottom view of an alternate design of the PCB of FIG. 3A, showing a disposable capacitive coupled PCB for integration with the capacitive coupled holder and disposable cartridge.

FIG. 3D shows a bottom view of a mating capacitively coupled PCB involving an additional embodiment including the capacitive coupled holder and disposable cartridge system.

FIG. 4 presents an exemplary schematic of an exemplary sensor including capacitive coupling integration.

FIG. 5A presents an image of an exemplary capacitive coupled holder including the bottom of a disposable cartridge system.

FIG. 5B presents an image of an exemplary cartridge docked to a mating printed circuit board on the capacitive coupled holder.

FIG. 5C presents an illustration of an alternate embodiment of the exemplary capacitive coupled holder of FIG. 5A in an open position.

FIG. 5D presents an illustration of an alternate embodiment of the exemplary capacitive coupled holder of FIG. 5A in a closed position.

FIG. 6 presents a schematic comparison between an exemplary miniaturized SAW sensor design according to the disclosure and an original SAW sensor design.

FIG. 7 presents a schematic of an exemplary fabricated wall concept for a SAW sensor.

FIG. 8 presents a diagram of an exemplary polydimethylsiloxane (PDMS) gasket.

FIG. 9 present an exemplary SAW biosensor system with an enclosure comprising overmolded thermoplastic elastomers (TPE).

FIG. 10A presents a perspective view of an exemplary embodiment of a SAW biosensor cartridge system.

FIG. 10B presents an exploded view of the exemplary embodiment of the SAW biosensor cartridge system in accordance to FIG. 10A.

FIG. 11A presents a perspective view of another exemplary embodiment of a SAW biosensor cartridge system.

FIG. 11B presents an exploded view of another exemplary embodiment of the SAW biosensor cartridge system in accordance with FIG. 11A.

FIG. 12A presents a perspective view of a further exemplary embodiment of a SAW biosensor cartridge system.

FIG. 12B presents an exploded view of the further exemplary embodiment of the SAW biosensor cartridge system in accordance with FIG. 12A.

FIG. 13 presents a perspective view of an exemplary embodiment of a SAW biosensor cartridge system adapted for collection and detection of gaseous species from the atmosphere.

FIG. 14 presents a perspective view of an exemplary embodiment of a SAW biosensor cartridge system adapted for collection and detection of bioaerosols from the atmosphere.

FIG. 15 presents a schematic of capacitive coupling of a SAW biosensor cartridge system.

FIG. 16 presents a schematic of a stackup view of a capacitive coupled device with PCB in cartridge.

FIG. 17 presents a schematic of the multipanel system.

FIG. 18 presents a schematic of the multipanel system.

FIG. 19 presents a data table demonstrating the ability of the system to detect SARS-CoV-2 serology in clinical samples.

FIG. 20A presents a perspective view of the disposable cartridge; and

FIG. 20B presents an exploded view of the disposable cartridge.

### DETAILED DESCRIPTION OF THE DISCLOSURE

Aspects of the present disclosure include apparatus, systems and platforms that are useful for the identification of chemicals, toxins, environmental agents and the like. The disclosed apparatus, systems and platforms may be used for diagnosis, treatment and/or prevention of any biological event of interest such as cardiac events, neurological events reproductive events and also include a variety of infectious diseases which may include those caused by bacteria, , immunological events fungi, viruses, and the like. The use of this biosensor is disclosed for human and animal use. The latter being used for both companion and food animals. Food safety and detection for biological research are also included in this application for the system described. The disclosed apparatus, systems and platforms may be used for detection of non-biological systems, such as chemotoxins and gaseous systems. The present disclosure is based, at least in part, on the applicant’s discovery that an integrated acoustic detection device such as a Surface Acoustic Wave (SAW) device can provide extremely sensitive detection of infectious disease-related antigens (e.g., SARS-CoV-2, SARS-CoV, MERS-CoV, human coronavirus OC43, human coronavirus HKU1, human coronavirus 229E, human coronavirus NL63and the like) in a sample. Infections afflicting animals such as canine heart worm, equine viruses and feline viruses can also be detected.

Previous publications of this applicant have described the use of different coatings, layers, signal amplification, interfaces with fluid materials, and multiplexing for use in SAW-based biosensors. Examples of such publications include U.S. Pat. Application Serial No. 16/629,309 filed Jan. 7, 2020, entitled “BIOACTIVE COATING FOR SURFACE ACOUSTIC WAVE SENSOR”; U.S. Pat. Application Serial No. 16/629,305 filed Jan. 7, 2020, entitled “METHODS AND APPARATUS FOR INTERFACING SENSORS WITH FLUID MATERIALS”; U.S. Pat. Application Serial No. 16/629,307 filed Jan. 7, 2020, entitled “MULTIPLEXING SURFACE ACOUSTIC WAVE SENSORS WITH DELAY LINE CODING”; and U.S. Pat. Application Serial No. 10/536,429 filed Apr. 27, 2006, entitled “ LINKING OF A SENSOR ELEMENT WITH A TRANSPONDER”, the disclosures which are hereby incorporated by reference in their entirety.

Crystals on the surface of acoustically transmissive materials such as quartz, lithium niobate and tantalate are typically only weakly responsive to the adhesion of biological materials. Chemical agents such as silane compounds following a series of proprietary application procedures along with reactive functional groups, such as amine residues, have been used to enhance adhesion of biological molecules on the surface crystals.

Other proposed techniques for modifying the crystal surface of SAW based biodetectors have included applying a layer of gold, silica or aluminum onto the surface of the crystal during fabrication. This approach at least partially coats the surface of the crystal with a metal that is more amenable to the attachment of biological molecules. Adding an aluminum layer on the crystal surface of an SAW biodetector to serve as a critical waveguide has also been attempted. However, while aluminum surfaces propagate acoustic waves very effectively, metals such as aluminum bind biological molecules poorly, and are therefore not optimal for use on the surface of SAW detection and diagnostic devices

Other approaches to modifying the crystal surface of SAW based biodetectors include applying a layer composed of a polymer, a ceramic such as SiO2, Poly (methyl methacrylate), or gold, on the surface of the SAW sensor to concentrate energy of the acoustic wave closer to the surface for effective analyte detection. Similarly a layer of silicone dioxide may enhance the binding ability of biological molecules without interfering with the transmission of the surface waver.

Previously described SAW based detection and diagnostic systems have not been available in the market due at least in part to their inability to effectively bind captured agents onto the surface of acoustically transmissive materials in a liquid environment and to carefully separate the liquid environment from the electronic components.

There remains an urgent world-wide need for a rapid, cost-effective, rapid, portable, sensitive, and robust point of care diagnostic test that can be used for the detection of a variety of biological analytes. In this way, the present disclosure fulfills all of these criteria and furthermore, takes advantage of many recent advances in semi-conductor industry (miniaturization, FPGA, software and hardware advances) and advances in cellular communications (on which these sensors are based) to provide a cost effective and easily used system that can replace 60 year old technologies such as lateral flow test.

Aspects of the present disclosure address this urgent need and overcome the various disadvantages of previously known systems and methods by providing an efficient, low-cost integrated surface acoustic wave (SAW) biosensor based system and method for point-of-care diagnostic use that is able to reliably identify biological samples having specific agents of interest, both infectious and non-infectious.

In one embodiment of the instant disclosure, an integrated surface biosensor system for the use as a rapid, cost-effective, and robust POC diagnostic for the detection of infectious events, agents, and systems is provided.

The techniques herein provide acoustic wave-based POC devices suitable for biological events (e.g. infection agent-virus) systems testing. The acoustic devices and methods described herein utilize a responsive piezoelectric material that responds to an electrical signal by creating an acoustic wave (i.e., very high frequency sound) as the fundamental sensing property.

Aspects of the present disclosure include a disposable cartridge system utilizing a surface acoustic wave (SAW) biosensor that can be used for the detection of infectious agents.

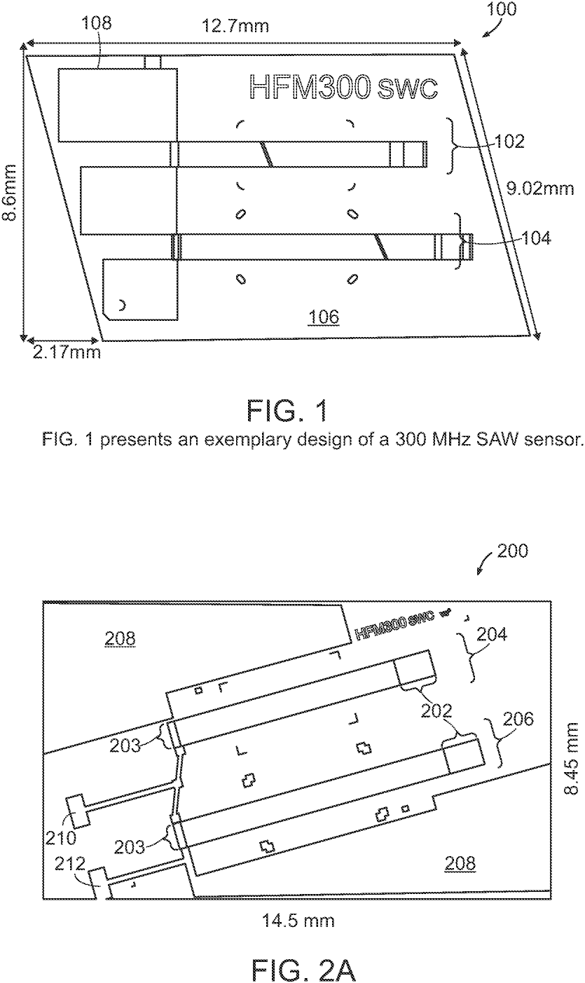

FIG. 1 presents an exemplary design of a 300 MHz SAW biosensor 100. According to some embodiments, the frequency range can extend from 150-900 MHz. The SAW biosensor may be activated by high frequency radiofrequency (RF) waves from a RF source. The SAW biosensor comprises a piezoelectric crystal base 106 and one or more metal surfaces 108. In some embodiments, the one or more metal surfaces 108 may be coated with a biofilm. The SAW biosensor may include a sample channel 102 and a reference channel 104. A biological sample may be contacted with the SAW biosensor via the sample channel 102 from which the biological sample may be analyzed. The output from the SAW biosensor may be processed by a printed circuit board (not shown in FIG. 1) coupled to the SAW biosensor for further analysis by the reader.

In some embodiments, sample channel 102 may be coated with one or more capture agents. In further embodiments, the sensing area of the SAW device may be a metalized (e.g., Al layer) and the piezoelectric crystal base 106 chosen may be, e.g., Lithium tantalate (LiTaO3). The SAW generated on this crystal may be called a leaky wave, which may be principally composed of a shear horizontal wave so it can operate in a liquid while keeping a low propagation loss. In some embodiments, a third channel (not shown in the figure) may be added to the SAW biosensor, which serves as a second reference channel to remove the effect of ambient temperature change on the SAW biosensor.

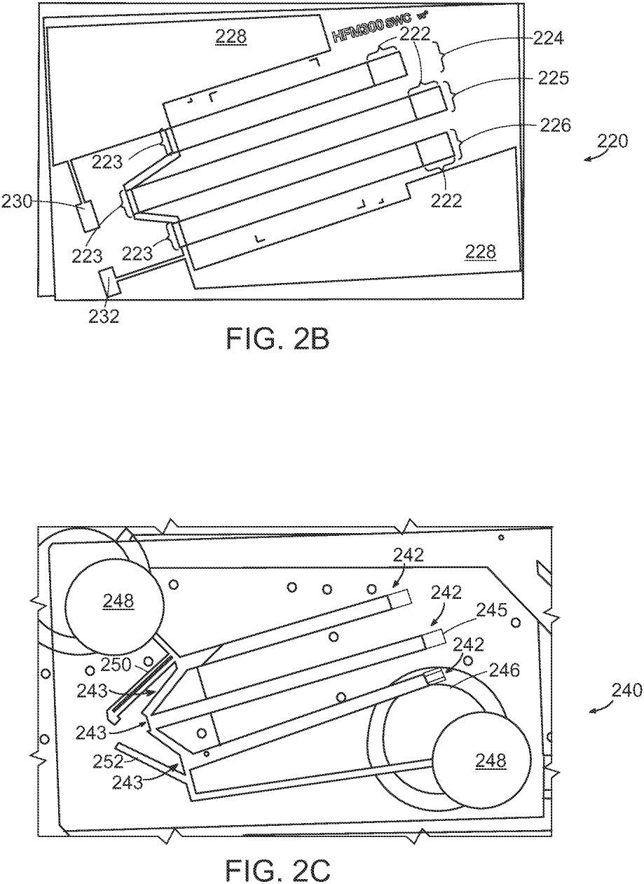

FIG. 2A shows an illustrative embodiment of a 300 MHz SAW sensor 200 according to an aspect of the present disclosure. According to some embodiments, the frequency range can extend from 150-900 MHz. The disclosed SAW sensor 200 includes a capacitive coupled contact pad 208 for establishing a capacitive coupling connection between the SAW sensor and a printed circuit board (PCB) supporting it. The disclosed SAW biosensor 200 includes a sample channel 204 for contacting the biological sample with the SAW biosensor and a reference channel 206. The sample channel 204 and reference channel 206 each have reflectors 202 and interdigitated transducers (IDTs) 203 for conversion of electrical energy to mechanical energy and vice versa.

FIG. 2B shows an exemplary design of a 300 MHz SAW sensor 220, which has been modified for capacitive coupling with metal contact pads and a third channel for temperature compensation. According to some embodiments, the frequency range can extend from 150-900 MHz. The disclosed SAW sensor 220 includes a capacitive coupled contact pad 228 for establishing a capacitive coupling connection between the SAW sensor 220 and a printed circuit board (PCB) (not pictured) supporting it. The disclosed SAW biosensor 220 includes a sample channel 224 for contacting the biological sample with the SAW biosensor 240, a compensation channel 225, and a reference channel 226. The sample channel 224, compensation channel 225, and reference channel 226 each have reflectors 222 and interdigitated transducers (IDTs) 223 for conversion of electrical energy to mechanical energy and vice versa.

FIG. 2C shows an exemplary design of a SAW sensor 240, which has been redesigned for capacitive coupling with circular metal contact pads to improve the X Y positioning tolerance on the capacitive coupled PCB. The disclosed SAW sensor 240 includes a capacitive coupled contact pad 248 for establishing a capacitive coupling connection between the SAW sensor 240 and a printed circuit board (PCB) (not pictured) supporting it. The disclosed SAW biosensor 240 includes a sample channel 244 for contacting the biological sample with the SAW biosensor 240, a compensation channel 245, and a reference channel 246. The sample channel 244, compensation channel 245, and reference channel 246 each have reflectors 242 and interdigitated transducers (IDTs) 243 for conversion of electrical energy to mechanical energy and vice versa.

A reader (not shown in FIGS. 2A-2C) may be connected to the SAW biosensors via the capacitively coupled contact pads 208 for interrogating the SAW sensor. Advantageously, capacitive coupling eliminates the need for pin connectors or wire bonding, which are less efficient and less economical for the SAW biosensor system. In an illustrative embodiment, the modified SAW biosensor may also include temporary contacts 210, 212 for probes used for quality control during fabrication.

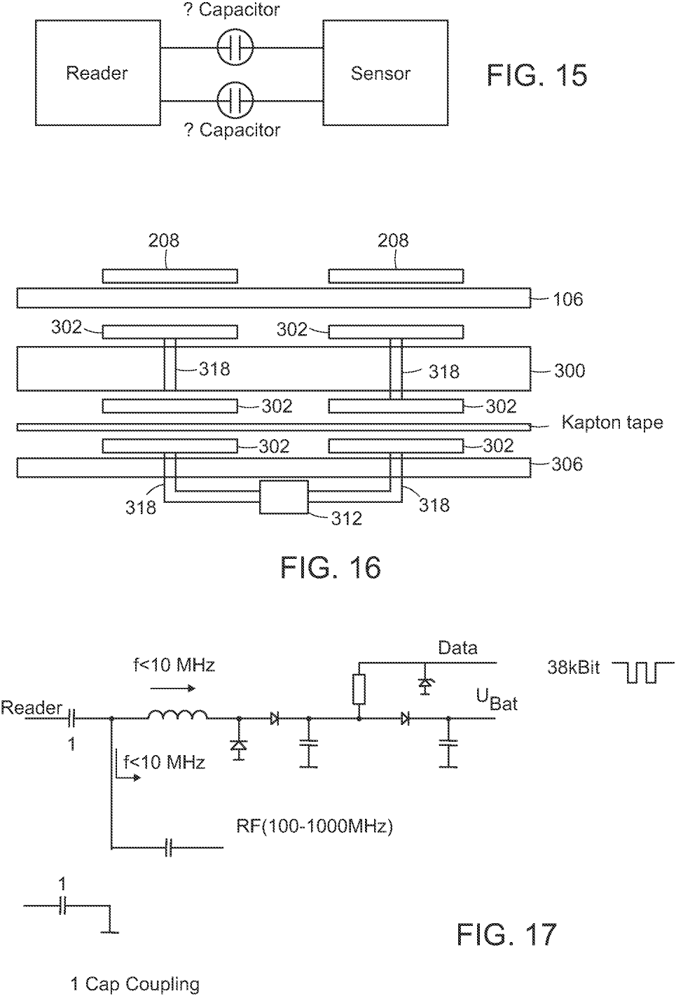

According to an aspect of the present disclosure, an input electrical signal from the reader is traversed through an IDT, a delay line, and then reflected back to the IDTs, where it is reconverted into an electrical signal. Changes in phase and amplitude of the electrical signal are measured by the reader. The phase change data and amplitude change data may then transformed by appropriate signal algorithms for detecting selected target components of a sample. According to an aspect of the disclosure, multiple IDTs can be configured in a series or in an electrical parallel arrangement. FIG. 15 demonstrates capacitive coupling to the SAW sensor with the use of a differential signal, determined by the voltage difference between the two capacitors. In certain embodiments, FIG. 16 demonstrates how capacitive coupling can be applied throughout multiple layers, with the SAW sensor on serving as a surface layer and the reader serving as a bottom layer. The RF electrical signal, in the range of 100 to 1000 MHz, is transmitted to the SAW sensor and partially reflected by the SAW sensor. This partially reflected portion is subsequently modified by the sensing effect in phase and amplitude, and this change is detected by the reader.

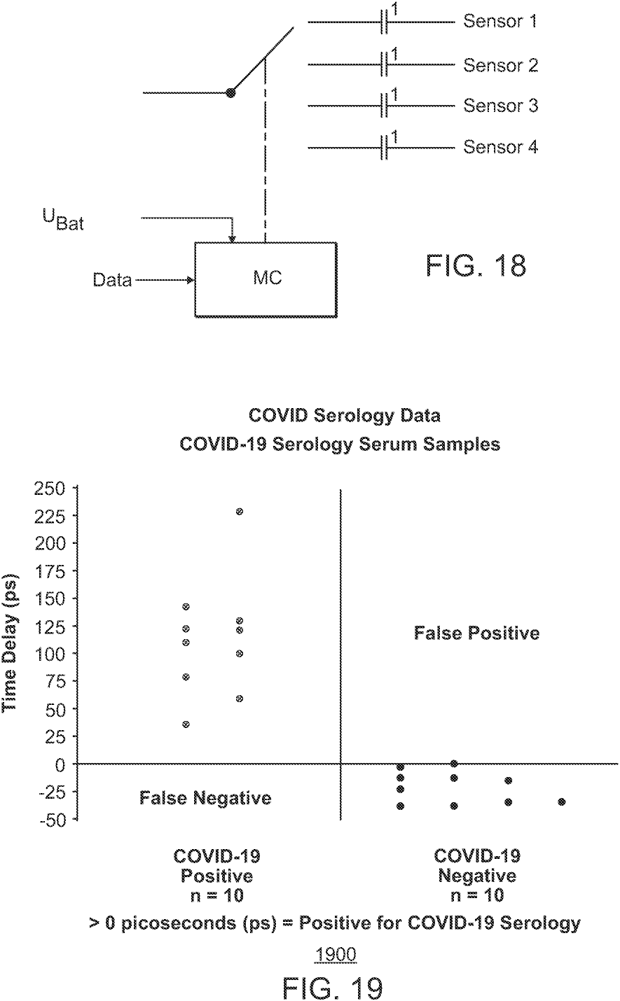

FIGS. 17 and 18 demonstrate a circuit of the electrical parallel arrangement, as the delay line connects the reader and a cartridge. In certain embodiments utilizing a multipanel approach, multiple SAW sensors are housed together within a cartridge, along with a switch which selects a sensor to interrogate. Upon stimulation, the switch routes an RF electrical signal in the range of 100 to 1000 MHz to the sensor currently being interrogated. To provide the switch with energy and the control signal, capacitive coupling enables the transfer of phase change data and amplitude change data, along with the energy transfer, across the circuit. Then, the system uses a 1 MHz carrier on/off control signal for the switch to enable the phase change data and amplitude change data, along with the energy transfer. Additionally, a third signal is rectified and used as energy supply to the switch and to the microcontroller, decoding the on/off keying to control the switch.

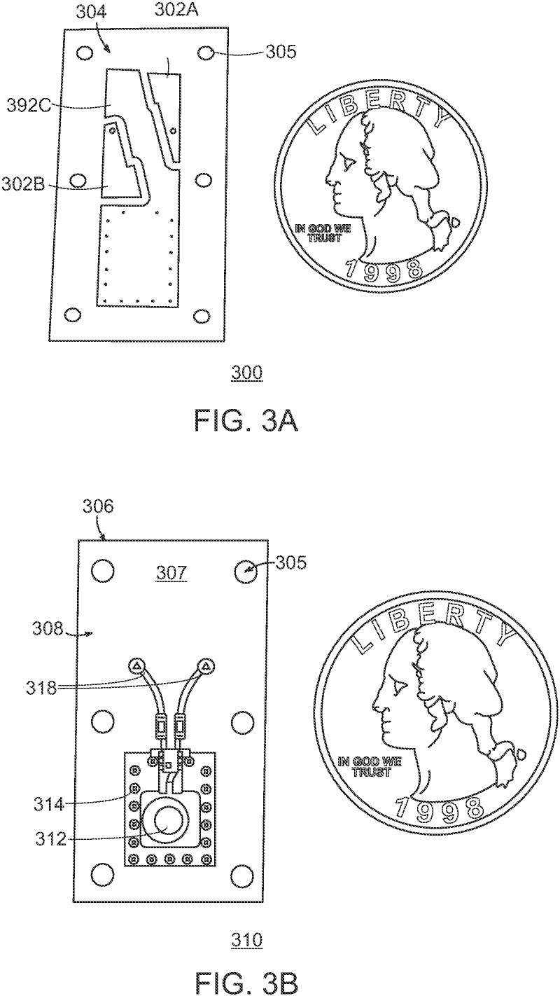

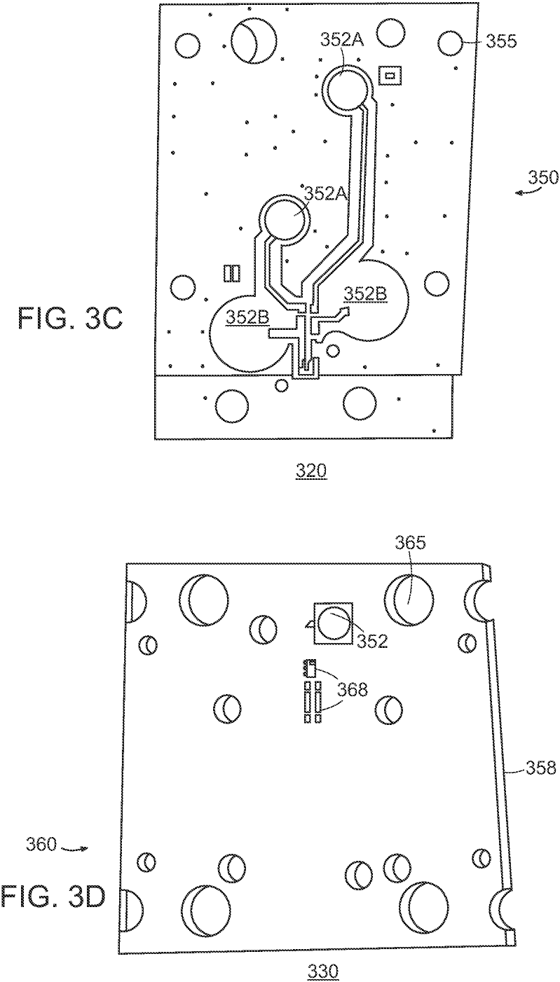

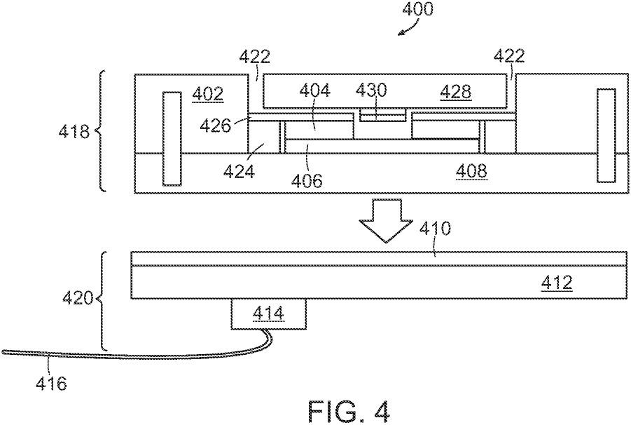

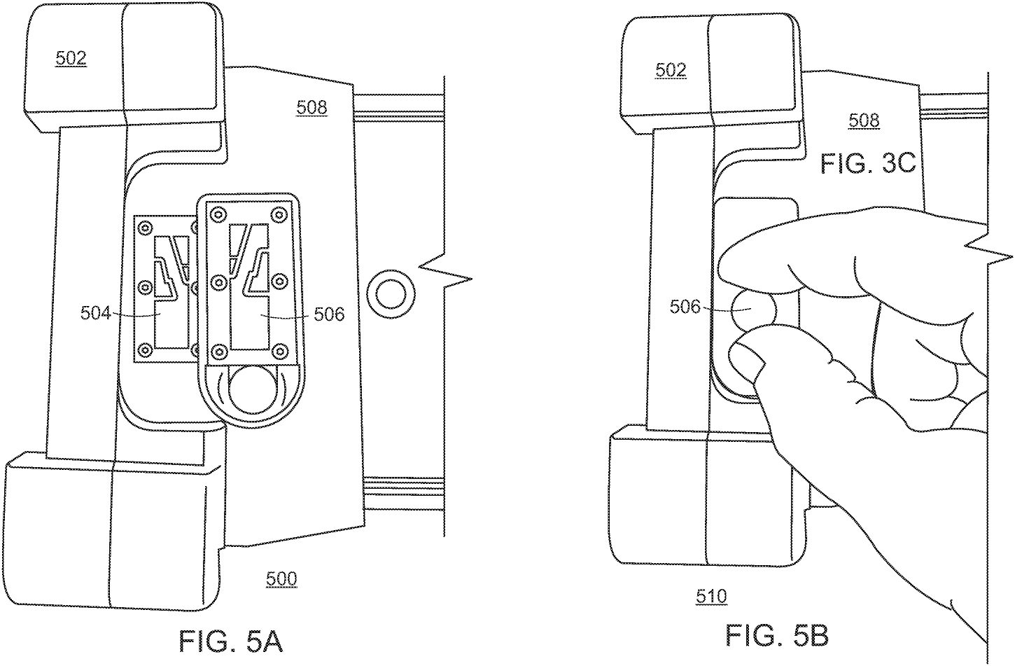

FIGS. 3A and 3B show a top view and a bottom view, respectively, of a mating capacitively coupled PCB 300. FIG. 3A shows PCB contacts 302A-C. A SAW sensor (not shown) is mated to a top surface 304 of a mating capacitive printed circuit board (PCB) 306 via the PCB contacts 302A-C. The PCB 306 also includes screw holes 305 along the perimeter through which screws will be used to secure the PCB 306 to a cartridge system (not shown in the figure).

FIG. 3B shows the bottom surface 308 of PCB 306 of a mating capacitive coupled PCB 300 having a sub miniature push-on (SMP) connector 312 for connecting to a reader unit (not shown in the figure) via a subminiature version A (SMA) cable (not shown in the figure). The SMP connector 312 is connected to the PCB contacts through a via 318. The SMP connector 312 is also surrounded by a perimeter enclosure 314. The SAW sensor and a disposable capacitive coupled PCB supporting it will be integrated into a disposable cartridge system (shown in FIGS. 3C and 3D) to be used for the POC detection of biological events of interest such as the SARS-CoV-2 virus. The cartridge mounts onto a designated area on top of the reader (not shown in this figure) where capacitive coupling occurs. The cartridge is disposable, unidirectional in its docking, and queried by a mating PCB mounted on the top of the reader connected with the RF circuit board inside the reader. A dielectric material, such as Kapton tape, may be used to protect the mating PCB. It is contemplated that the dielectric material can consist of several layers, including the piezoelectric substrate of the SAW element, an additional air layer, and additional layers from the cartridge housing or the reader housing, which can act as a dielectric layer. The capacitive coupling PCB relays information into the reader from the cartridge in a simple passive proximity coupling with no direct physical connection or mating pins required.

Aspects of the present disclosure further includes a disposable cartridge system utilizing a surface acoustic wave (SAW) biosensor, disposable capacitive coupled PCB assembly, fluid gasket, buffer can that contains saline, and a screw cap that can be used for the detection of infectious agents.

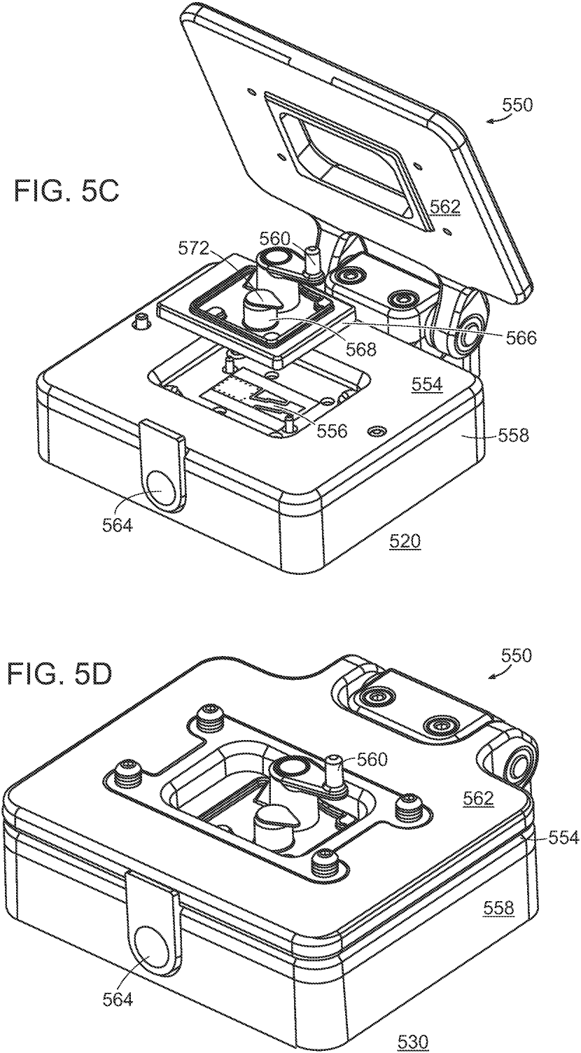

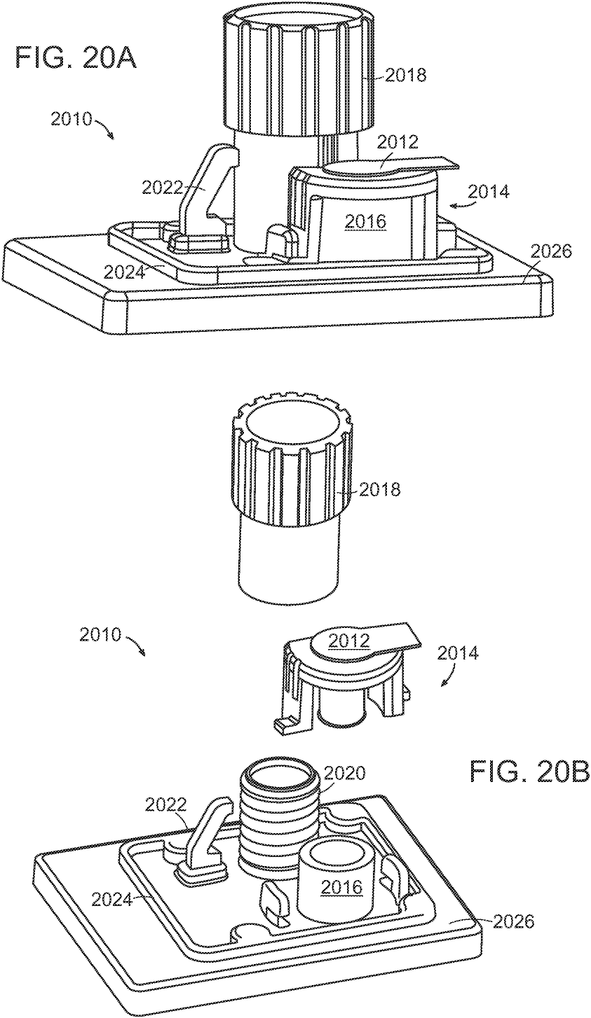

FIG. 20A shows a perspective view of the disposable cartridge 2010, and FIG. 20B presents an exploded view of the disposable cartridge 2010. According to some embodiments, disposable cartridge 2010 is akin to cartridge 566 as described and depicted in FIGS. 5C and 5D, and can be docked onto the capacitive coupled holder 550 and wait for calibration. As shown in FIGS. 20A and 20B, cartridge system 2010 includes top foil 2012 disposed over buffer can 2014, which can be removed by a user once calibration is complete to pierce a foil (not shown) at the bottom of buffer can 2014. As shown in FIG. 20B, buffer can 2014 is configured to mated with cylinder 2016 during assembly. Cartridge system 2010 also includes screw cap 2018 and clamp 2022, which can be activated by a user to activate the flow of, for example, saline from the buffer can 2014 through the channel 2020 over the sensory aspect (not shown) of cartridge 2010. This permits the user to add the sample (not pictured) to the buffer can 2014 and turn the screw cap 2018 again, which activates the flow of the sample from the buffer can 2014 through the channel 2020 over the sensory aspect of cartridge 2010. According to the example embodiments, each of these components is located within perimeter 2024, and is disposed on base 2026.

FIG. 3C presents a bottom view 320 of an alternate design of the PCB of FIG. 3A, showing a disposable capacitive coupled PCB 350, for integration with the capacitive coupled holder and disposable cartridge. The disposable capacitive coupled PCB 350 includes PCB contacts 352A-B. A SAW sensor (not shown) is mated to a top surface (not shown) of the disposable capacitive PCB 350 via the PCB contacts 352A-B. The PCB 350 also includes screw holes 355 along the perimeter through which screws will be used to secure the PCB 350 to a cartridge system (not shown). Further, the present embodiment incorporates a radio-frequency identification (RFID) tag (not shown), which is interrogated by the reader (not shown) via a mating capacitive coupled PCB 360 (introduced in FIG. 3D). The RFID tag can contain data on the disposable cartridge, including but not limited to, test ID, lot number, expiration date, and calibration data.

FIG. 3D shows a bottom view 330 of a mating capacitively coupled PCB 360 involving an additional embodiment including the capacitive coupled holder and disposable cartridge system. FIG. 3D shows bottom surface 358 of PCB 360 of a mating capacitive coupled PCB having a sub miniature push-on (SMP) connector 352 for connecting to a reader unit (not shown) via a subminiature version A (SMA) cable (not shown). The SMP connector 352 is connected to the PCB contacts through a via 368. The PCB 360 also includes screw holes 365 along the perimeter through which screws will be used to secure the PCB 360 to a holder (not shown).

The SAW sensor and a disposable capacitive coupled PCB supporting it will be integrated into disposable cartridge systems to be used for the POC detection of biological events of interest such as the SARS-CoV-2 virus. The cartridge mounts onto a designated area on top of the reader (not shown in this figure) where capacitive coupling occurs. The cartridge is disposable, unidirectional in its docking, and queried by a mating PCB mounted on the top of the reader connected with the RF circuit board inside the reader. A dielectric material, such as Kapton tape, may be used to protect the mating PCB. It is contemplated that the dielectric material can consist of several layers, including the piezoelectric substrate of the SAW element, an additional air layer, and additional layers from the cartridge housing or the reader housing, which can act as a dielectric layer. The capacitive coupling PCB relays information into the reader from the cartridge in a simple passive proximity coupling with no direct physical connection or mating pins required.

Referring now to FIG. 4, an exemplary schematic of the capacitive coupling integration complex 400 as discussed in FIGS. 3A and 3B is present. In the exemplary embodiment discussed in FIG. 4, the disposable cartridge region 418 may include a top surface 402 for holding the biological sample, a SAW biosensor 406 for contacting the biological sample and at least one gasket 404 to prevent the fluid from directly overwhelming and damaging the SAW biosensor 406. The SAW biosensor 406 and the at least one gasket 404 are held in place with a top securing portion 426 and a bottom securing portion 424. The top securing portion 426 directly rests on the bottom securing portion 424 and the at least one gasket 404 to hold at least one gasket 404 and the SAW biosensor 406 in place. A top layer securing unit 428 comprising a flange 430 mates with the top securing portion 426 such that the flange 430 secures the region of the SAW biosensor 406 not covered by the at least one gasket 404. The top layer securing unit 428 is flanked by microfluidic channels 422 for fluid flow. The SAW biosensor 406 may be directly coupled to a disposable PCB with no connector 408 for interfacing with a reusable contact region 420 of a reader. The disposable PCB with no connector 408 may be contacted with a dielectric material 410 such as polytetrafluoroethylene (PTFE) or Kapton™ tape for protecting the mating PCB 412 from environmental factors and providing an immunity barrier. The data from the mating PCB 412 may be transmitted through a connector 414 and a cable 416 directed to the reader.

Referring now to FIGS. 5A and 5B, exemplary images of the cartridge-reader complex in an open position 500 and a closed position 510, respectively. FIG. 5A presents an exemplary image of the cartridge-reader complex in an open position 500, and shows that the reader 502 includes a base 508 and a mating PCB region 504 for connecting with a PCB 506 of the cartridge (not shown in this figure) where the PCB 506 of the cartridge is not connected to the mating PCB region 504 of the reader 502. FIG. 5B presents an exemplary image of the cartridge-reader complex in the closed position 510, and shows PCB 506 of the cartridge when reader 502 is in a closed position 510.

Referring now to FIGS. 5C and 5D, exemplary images of the capacitive coupled holder and disposable cartridge system in an open position 520 and a closed position 530, respectively. FIG. 5C presents an exemplary image of the capacitive coupled holder and disposable cartridge system 550 in an open position 520, and shows that the system 550 includes a top 562, latch 564, base 558 and a capacitive coupled pad 554 for connecting with a mating PCB 556 which interfaces cartridge 566 to the holder 550. FIG. 5D presents an illustration of the alternate embodiment of the capacitive coupled holder and disposable cartridge system 550 in a closed position 530. Further, screw cap 560 disposed on cartridge 566 can be actuated by the user in some embodiments. The cartridge 566 is placed onto the capacitive coupled pad 554 and secured in place by closing the holder assembly via latch 564. Similarly to the embodiment introduced in FIGS. 3C and 3D, during operation, a user can dock a cartridge 566 onto the capacitive coupled holder 550 and wait for calibration. According to the present disclosure, once calibration is done, a user may remove the top foil 572 from the buffer can 568. The user can then turn the buffer can 568, which pierces a foil (not pictured) at the bottom of it. Next, the user can turn the screw cap 560, which activates the flow of saline from the buffer can through the channel over the sensory aspect of cartridge 566. This permits the user to add the sample (not pictured) to the buffer can 568 and turn the screw cap 560 again, which activates the flow of the sample from the buffer 568 can through the channel over the sensory aspect of cartridge 566.

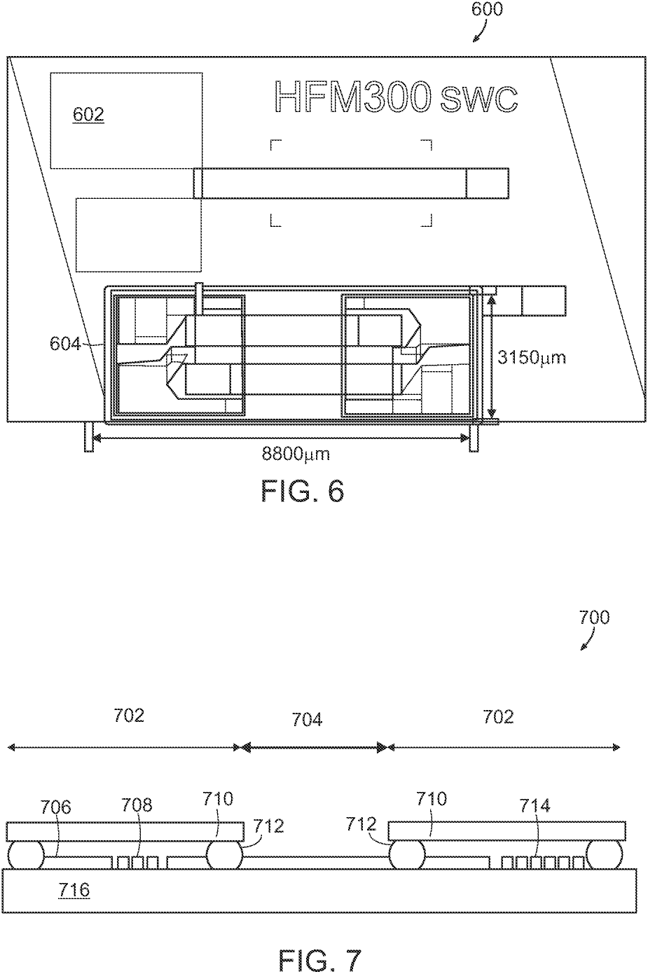

Referring now to FIG. 6, a comparison between a miniaturized SAW sensor 604 design and an original SAW sensor design 602 is presented. According to an aspect of the present disclosure, the miniaturized SAW sensor 604 may be designed for capacitive coupling with a pair of contact pads opposing each other.

Referring now to FIG. 7, an exemplary schematic of a fabricated wall 700 for a SAW sensor is presented. To ensure that the IDTs 203 and reflectors 202 (shown in FIGS. 2A-2C), which drive the SAW biosensor, may be protected from the fluid flow of saline and the biological sample, a fabricated wall concept may be adopted. A leaking fluid wall may destroy the SAW signal conveying the radiofrequency wave into the crystal via the capacitive coupled contact pads 208 and IDT s 203 leading to signal loss, affecting the functioning of the sensor. In one embodiment of the present disclosure, a fabricated wall concept may be adopted where the SAW biosensor 716 has been identified to have open sensing areas 704 and liquid-proof protecting areas 702. In the regions of liquid-proof protection 702, regions of contacts pads 706 and regions of IDTs 708 are isolated from the fluid flow via lid silicon glass 710 adhered on to the SAW biosensor 716 visa seal-proof silicon rubber wall 712.

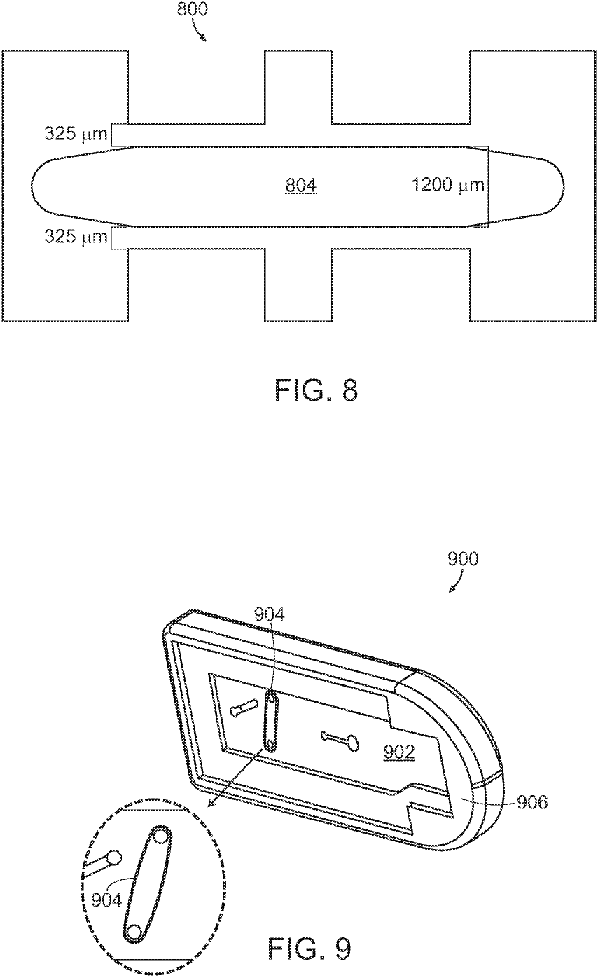

Referring now to FIG. 8, an exemplary diagram of a polydimethylsiloxane (PDMS) gasket 800 is presented. To further isolate fluid flow from the sensitive electrical components, the system may include a PDMS gasket 800 to prevent the SAW biosensor from directly interacting with the fluid flow. The PDMS gasket 800 comprises a fluidic channel 804 created by the gasket to allow the biological sample to flow through. In some embodiments, as in the case of FIG. 8, the gasket may be made of PDMS.

Referring now to FIG. 9, an exemplary SAW biosensor system 900 with an enclosure comprising overmolded thermoplastic elastomers (TPE) is presented. The SAW biosensor system 900 may include an overmolded TPE gasket 904 on a top surface 902 of a cassette component 906. The system may be completely enclosed using walls of silicone or overmolded thermoplastic elastomers (TPE) which are precisely tooled to the dimensions of the sensor, allowing for a flow well with the characteristics needed for a dynamic flow cell. Such an enclosure would work for acoustic sensors using other types of acoustic waves, such as Rayleigh, with or without a Love layer, transmission and reflective delay lines, and with bulk acoustic waves. Any type of acoustic wave traversing a piezoelectric crystal could be used in such an enclosure. All electronic components are protected, and the flow cell ties perfectly to the larger fluidic channel.

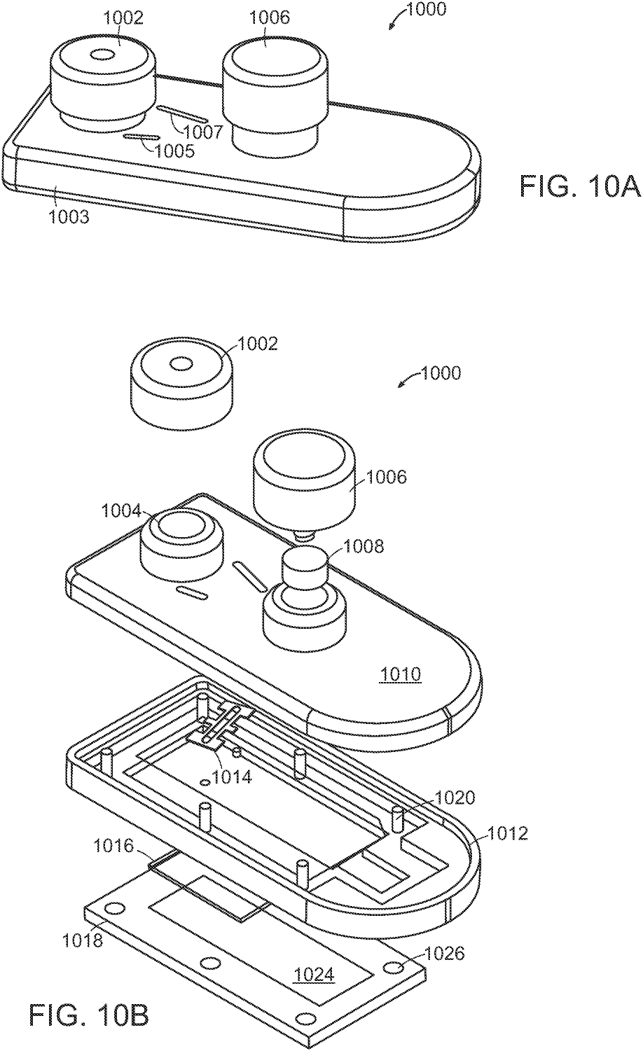

FIGS. 10A and 10B present perspective and exploded views of an exemplary embodiment of disposable cartridge system 1000 comprising a SAW biosensor for the detection of infectious diseases. The exemplary embodiment of the disposable cartridge system 1000 may include a cassette 1003 including a cassette body 1010 and a cassette bottom 1012 secured together for holding the sample. The cassette body 1010 and the cassette bottom 1012 may be secured to each other via vertical posts 1020, for example. The disposable cartridge system 1000 also includes a SAW biosensor 1016 attached to a printed circuit board 1018. The printed circuit board 1018 is then attached to the cassette bottom 1012. The printed circuit board 1018 may be secured to the cassette bottom 1012 via screws (not shown in the figure) through the screw holes 1026 along the perimeter of the printed circuit board 1018, for example. The disposable cartridge system also includes a gasket 1014 to separate the biological sample from coming in contact with the SAW biosensor 1016 and the printed circuit board 1018. The printed circuit board 1018 includes a region 1024 comprising printed circuit board contacts (not shown).

According to an aspect of the present disclosure, the cassette 1003 includes outlines of internal fluidic pathways 1005, 1007. A biological sample may be placed in a sample well 1004 and secured with a sample cap 1002 on the cassette body 1010. In an illustrative embodiment, the sample cap 1002 includes an air vent 1003. The disposable cartridge system 1000 may be secured onto a reader (not shown) for calibration.

Following calibration, a saline cap 1006 comprising a spring 1007 is pushed down on a saline-saturated compression pad 1008 on the cassette body 1010. The rebounding spring force of the spring 1007 in the saline cap 1006 may be designed to allow the saline-saturated compression pad 1008 to decompress and pull the saline back into the saline-saturated compression pad 1008 at a controlled rate. The saline cap 1006 is then pushed down against the spring 1007 causing the saline in the saline-saturated compression pad 1008 to flow through a channel over the SAW biosensor 1016 to the sample well 1004.

The SAW biosensor 1016 is in direct communication with the printed circuit board 1018 which processes the output response of the SAW biosensor 1016 to the biological sample. The disposable cartridge system 1000 may be operatively placed in a reader so that an output of the disposable cartridge system may be received by the reader. The output of the disposable cartridge system 1000 may include a measurement or indication of SARS-CoV-2 virus being present in the biological sample, for example.

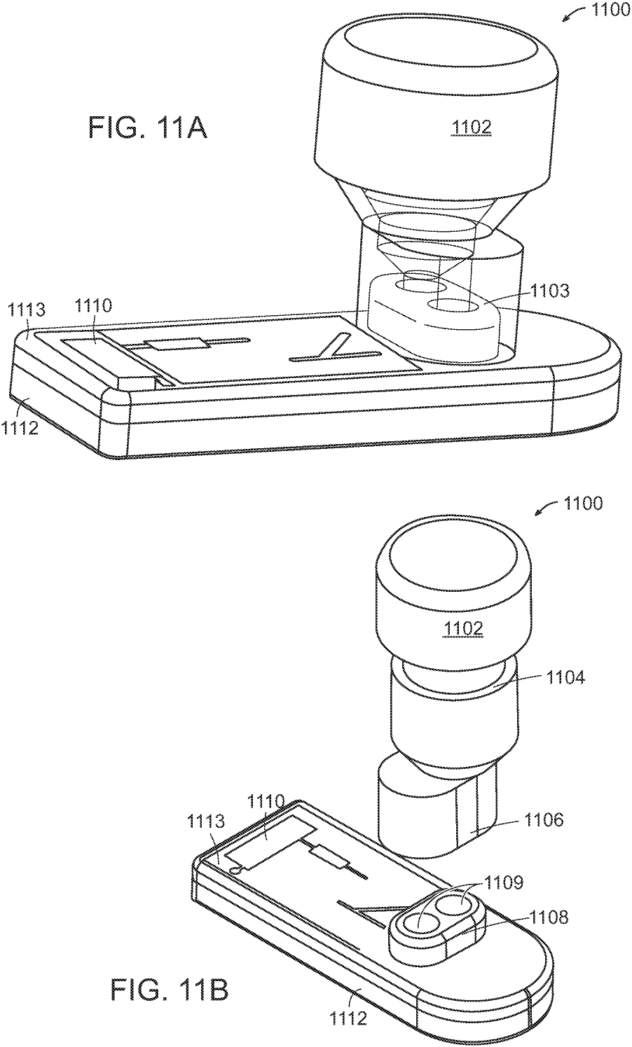

FIGS. 11A and 11B present a perspective and exploded view of another illustrative embodiment of disposable cartridge system 1100 comprising a SAW biosensor for the detection of infectious diseases according to aspects of the present disclosure. The disposable cartridge system 1100 comprises a cassette body structure 1112 and a cassette top cover 1113 secured together and comprising a SAW biosensor, a printed circuit board, and a gasket to prevent the biological sample from directly being contacted with the SAW biosensor. According to an aspect of the present disclosure, a biological sample may be placed in a sample well 1104 and secured with a sample cap 1102.

The cassette body structure 1112 may be placed on a reader (not shown) for calibration. Saline pinch valves (not shown) in the cassette body structure 1112 may be activated when the cassette body structure 1112 is placed on a reader for calibration.

The sample well 1104 containing the biological sample secured with a sample cap 1102 is attached to a saline well 1106 to form a sample-saline complex 1103 and loaded onto the cassette top cover 1113 via a docking location 1108. The docking location 1108 comprises at least two loading wells 1109. In one aspect of this exemplary embodiment, the sample well 1104 and the saline well 1106 comprise foils securing the respective liquids in their respective well. When the sample well 1104 and the saline well 1106 are attached to the loading wells 1109, the foils are pierced and the saline pinch valve is opened, exposing saline and the sample to channels (not shown) in the cassette body structure 1112.

According to an aspect of the present disclosure, the saline pinch valves are designed to be opened first to allow saline to flow over the SAW biosensor and contact the absorbent wicking pad 1110 on the cassette body structure 1112. In an illustrative embodiment, the absorbent wicking pad 1110 pulls the saline at a rate of 5 µl/min. Proceeding the opening the saline pinch valve for 5 minutes, the saline pinch valve is closed and the sample is allowed to be exposed to the SAW biosensor and then contact the absorbent wicking pad 1112. The SAW biosensor may be in direct communication with the printed circuit board which in turn processes the output of the SAW biosensor due to the biological sample and an output of measurement (e.g., presence of an infectious virus in the biological sample) may be noted by the reader when the disposable cartridge system 1100 is placed in the reader.

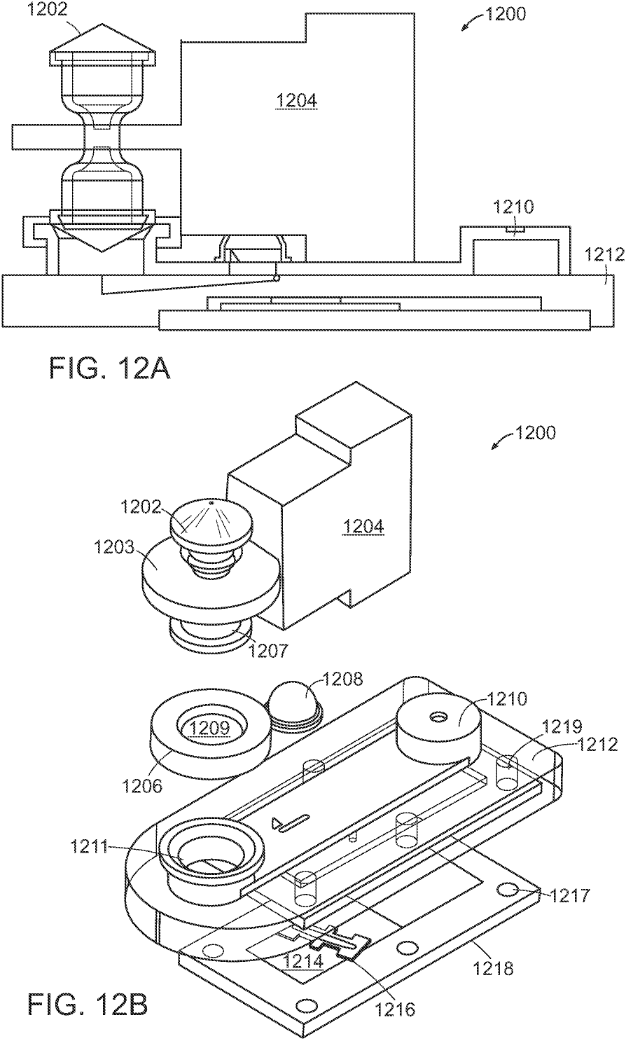

FIGS. 12A and 12B present a perspective and exploded view of a further exemplary embodiment of disposable cartridge system 1200 comprising a SAW biosensor for the detection of infectious diseases. The exemplary embodiment of the disposable cartridge system 1200 comprises a cassette body 1212 further comprising a saline blister pack 1208, SAW biosensor 1214 attached to a printed circuit board 1218, and a gasket 1216 to separate the biological sample from coming in contact with the SAW biosensor 1214 and the printed circuit board 1218. The printed circuit board 1218 is secured onto the cassette body 1212 via posts 1219 which fit on the post voids 1217 on the perimeter of the printed circuit board 1218. The biological sample may be placed in a sample well 1211 and secured with a flexible sample cap 1206 on the cassette body 1212. The disposable cartridge system 1200 may be secured onto a reader (not shown) for calibration. Following calibration, a reusable flexible hourglass with grains 1202 held by a holding platform 1203 of a timer holder 1204 may be placed on the cassette body 1212, leading to opening the saline blister pack 1208. As grains in the hourglass 1202 slowly transfer to the bottom of the hour-glass 1207 and compress the indented region 1209 of a flexible sample cap 1206, the biological sample may be forced into the channel (not shown in the figures) in the cassette body 1212, and allowed to interact with the SAW biosensor 1214 Eventually the saline from the saline blister pack 1208 and the biological sample are displaced to the waste well with an air vent 1210. The SAW biosensor 1214 may be in direct communication with the printed circuit board 1218 which in turn processes the output of the SAW biosensor 1214 due to the biological sample and an output of measurement (e.g., presence of a virus in the biological sample) may be noted in the reader when the disposable cartridge system 1200 is placed in the reader.

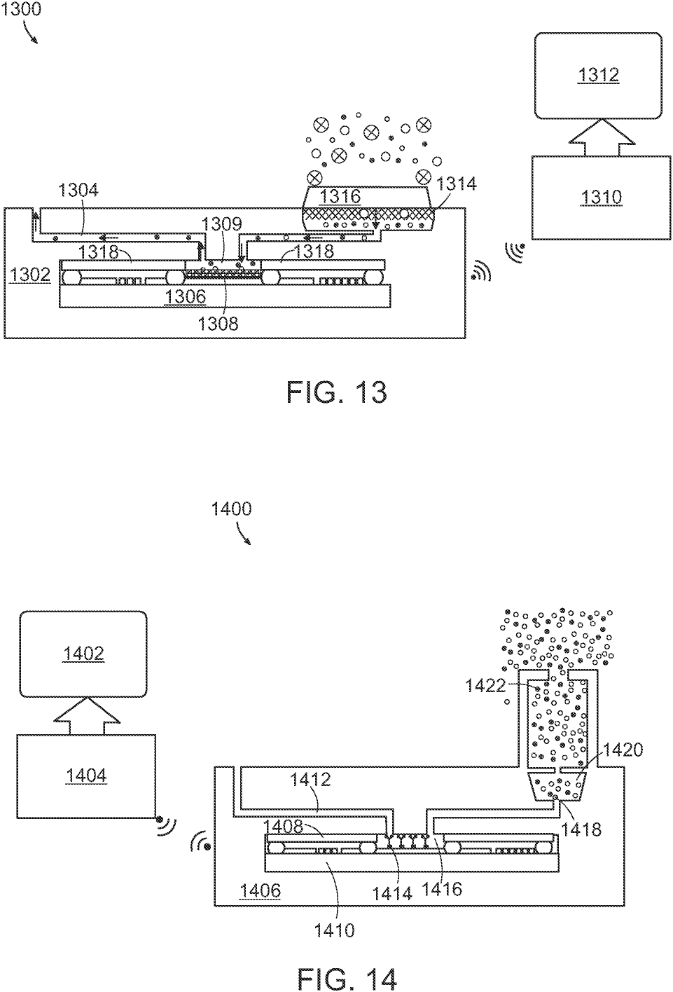

Referring now to FIG. 13, a perspective view of an exemplary embodiment of a SAW biosensor cartridge system 1300 adapted for collection and detection of gaseous species from the atmosphere is presented. The SAW biosensor cartridge system 1300 includes a cassette 1302 with a sensor 1306 which may include a liquid-proof sealing 1318, only revealing a sensing area 1309 coated with an active nanomaterial layer 1308. The cassette 1302 includes a porous inlet 1316 with a filter 1314 for gaseous species input from the atmosphere. The gaseous species input may travel through a channel 1304 connected to a micropump (not shown in the figure) allowing the gaseous species input to flow through the channel 1304 for interaction with the sensing area 1309 coated with an active nanomaterial layer 1308. In one embodiment, the data from the sensor 1306 may then be transmitted to a tablet 1312 connected to a reader (not shown in the figure) via a wireless radio frequency interrogator 1310.

Referring now to FIG. 14, a perspective view of an exemplary embodiment of a SAW biosensor cartridge system adapted for collection and detection of bioaerosols from the atmosphere. The SAW biosensor cartridge system 1400 includes a cassette 1406 with a sensor 1410 which may include a liquid-proof sealing 1408, only revealing a sensing area 1416 coated with a capture agent 1414. The cassette 1402 includes a bioaerosol sampler system 1422 with a bioaerosol collection reservoir 1420 for holding the bioaerosol input from the atmosphere. The bioaerosol collection reservoir 1420 is fluidly connected to a channel 1412 via a valve 1418. The sample bioaerosol may travel through the channel 1412 connected to a micropump (not shown in the figure) allowing the bioaerosol input to flow through the channel 1412 for interaction with the sensing area 1416 coated with the capture agent 1414. In one embodiment, the data from the sensor 1410 may then be transmitted to a tablet 1402 connected to a reader (not shown in the figure) via a wireless radio frequency interrogator 1404.

FIG. 19 presents a data table 1900 demonstrating the ability of the systems of the present disclosure to detect SARS-CoV-2 serology in clinical samples. According to the illustrative example, a sensor surface was immobilized with a recombinant SARS-CoV-2 spike receptor-binding domain (RBD) protein for capturing SARS-CoV-2 IgG antibodies. SARS-CoV-2 IgG positive (n=10) and negative (n=10) human serum samples were evaluated without any sample processing with results obtained on average in 5.5 minutes. The results from this preliminary study indicate ability of the system to detect SARS-CoV-2 IgG antibodies in clinical samples with 100% sensitivity and 100% specificity. Thus, data table 1900 shows that the platform and the systems and devices of the present disclosure have the potential to be a POC method for improved detection of host generated antibodies against SARS-CoV-2 and other infectious diseases.

It should be understood, that for various embodiments described herein, the disposable cartridge handling potential infectious or other material needs to be biologically isolated from the reader being reused and may need to be discarded since it now may contain biological fluids. Having only a flat surface and no electrical or mechanical contacts is therefore preferable and eases the disinfection of the reader after usage. This implementation may implement a noncontact drive for pumping the analytes if this pump is needed. For example, a pump in the cartridge can be energized by means of a magnet in the reader moving a piston in the cartridge through magnetic coupling through a protection diaphragm. Alternatively, the diaphragm can be displaced by pressurizing a cavity underneath a diaphragm on the reader side and pushing in a corresponding diaphragm on the cartridge side.

There are many instances when a rapid, portable, and accurate testing platform can add critical data to diagnose, leading to diagnosis of rapidly evolving biological events including proper treatment and decrease spread of infectious agents. Such a system which can trace, analyze and handle large amounts of data related to such a diagnosis is critical for prevention, treatment, and managing future outbreaks. Other examples of such utility can include non-infectious conditions such as chemo or bio toxin threats, where remote and constant monitoring can identify and isolate a person or non-persons carrying or distributing such materials using this technology. In addition, diagnosis of veterinary and human situations (disease and wellness) that can identify and treat rapidly can make a difference such as biomarkers which can rapidly identify traumatic brain injury, stroke, or myocardial infarction. These systems could also be useful in food safety testing and in biological research and production.

Although aspects of the present disclosure and certain examples are described herein in terms of biological samples or infectious samples, it should be understood by persons having ordinary skill in the art that the aspects and various alternative embodiments of the present disclosure could be performed on or implemented to detect non-biological and/or non-infectious analytes or samples and the like, within the scope of the present disclosure.

Although various aspects of the present disclosure are described herein in terms of various exemplary embodiments, it should be understood that variations and modifications may be made to the disclosure described herein to adopt it to various usages and conditions within the scope of applicant’s invention as claimed herein.

The recitation of a listing of elements in any definition of a variable herein includes definitions of that variable as any single element or combination (or sub-combination) of listed elements. The recitation of an embodiment herein includes that embodiment as any single embodiment or in combination with any other embodiments or portions thereof.

All patents and publications mentioned in this specification are herein incorporated by reference to the same extent as if each independent patent and publication was specifically and individually indicated to be incorporated by reference.

What is claimed is:

1. An integrated surface acoustic wave biosensor system for point-of-care diagnostic use, the system comprising:
a disposable cartridge component; and
a reusable reader contact region,
wherein the disposable cartridge component comprises:
three channel sensor or multipanel sensors of SAW origin
a sample well for addition of a biological sample;
a saline-saturated absorbent pad or a reagent bubble;
an integrated surface acoustic wave (SAW) biosensor;
a printed circuit board (PCB) coupled to the SAW biosensor;
a gasket;
Ex-cartridge processes for pre-processing samples including tubes, syringes and filters and
a cassette for housing the sample well, the saline-saturated compression pad, the SAW biosensor, the printed circuit board, the gasket; and wherein the reusable reader contact region comprises:
a mating PCB configured to couple to the PCB to the SAW biosensor in the disposable cartridge component; and
a connector configured for securing a cable for transmitting data from the mating PCB to the reusable reader.

2. The system of claim 1, further comprising a dielectric material coupled to the mating PCB of the reusable reader contact region.

3. The system of claim 2, wherein the dielectric material is Kapton tape.

4. A disposable cartridge component of an integrated surface acoustic wave biosensor system for point-of-care diagnostic use, the disposable cartridge component comprising:
a sample well for addition of a biological sample;
a saline-saturated absorbent pad or a reagent bubble;
an integrated surface acoustic wave (SAW) biosensor;
a printed circuit board (PCB) coupled to the SAW biosensor;
a gasket; and
a cassette for housing the sample well, the saline-saturated compression pad, the SAW biosensor, the printed circuit board, the gasket.

5. The disposable cartridge of claim 4, wherein the saline-saturated absorbent pad is compressed with a saline cap comprising a spring.

6. The disposable cartridge of claim 4, further comprising a sample cap with an air vent to secure the sample well.

7. The disposable cartridge of claim 4, wherein the SAW biosensor comprises a sample channel and a reference channel.

8. The disposable cartridge of claim 7, wherein the SAW biosensor further comprises a second reference channel.

9. The disposable cartridge of claim 4, wherein the SAW biosensor comprises a piezoelectric crystal base.

10. The disposable cartridge of claim 9, wherein the piezoelectric crystal base is lithium tantalite.

11. The disposable cartridge of claim 4, wherein the SAW biosensor further comprises capacitive coupled contact pads.

12. A disposable cartridge component of an integrated surface acoustic wave biosensor system for point-of-care diagnostic use, the disposable cartridge component comprising:
a sample well for addition of a biological sample;
a saline well comprising saline for coupling with the sample well;
a cassette body structure comprising an integrated surface acoustic wave (SAW) biosensor, a printed circuit board (PCB) coupled to the SAW biosensor for, and a gasket;
a docking station on the cassette body structure for coupling with the saline well and sample well; and
an absorbent wicking pad.

13. The disposable cartridge component of claim 12, wherein the sample well and the saline comprises foils to secure the biological sample and the saline.

14. The disposable cartridge component of claim 12, wherein the cassette body structure comprises at least one saline pinch valve and at least one sample channel valve.

15. The disposable cartridge component of claim 14, where the saline pinch valve is opened when the saline well is coupled to the docking station.

16. The disposable cartridge component of claim 12, wherein the absorbent wicking pad pulls saline at a rate of 5 µl/min.

17. The disposable cartridge component of claim 12, wherein the gasket is made of polydimethylsiloxane (PDMS).

18. The disposable cartridge component of claim 12, wherein the SAW biosensor comprises a sample channel and a reference channel.

19. A disposable cartridge component of an integrated surface acoustic wave biosensor system for point-of-care diagnostic use, the disposable cartridge component comprising:
a sample well for addition of a biological sample;
a reusable flexible hourglass with grains;
a timer holder for holding the flexible hourglass with grains;
a flexible sample cap for securing the sample well;
a saline blister pack comprising saline; and
a cassette body comprising an integrated surface acoustic wave (SAW) biosensor, a printed circuit board (PCB) coupled to the SAW biosensor for, and a gasket.

20. The disposable cartridge component of claim 19, further comprising a waste well with an air vent for the displaced biological sample and saline.

21. The disposable cartridge component of claim 19, wherein the SAW biosensor comprises a sample channel and a reference channel.

22. The disposable cartridge component of claim 16, wherein the SAW biosensor is enclosed with an overmolded thermoplastic elastomer.

23. A method for detecting a target analyte in a biological sample using an integrated surface acoustic wave biosensor system, the method comprising:
providing a disposable cartridge component of the integrated surface acoustic wave biosensor system, wherein the disposable cartridge component comprises:
a sample well for addition of the biological sample;
a saline-saturated absorbent pad;
an integrated surface acoustic wave (SAW) biosensor;
a printed circuit board (PCB) coupled to the SAW biosensor;
a gasket; and
a cassette for housing the sample well, the saline-saturated compression pad, the SAW biosensor, the printed circuit board, the gasket; and
providing the biological sample into the sample well;
applying surface acoustic waves to the sample in the sample well to generate a characteristic electrical signal of the biological sample; and
detecting the target analyte based on the characteristic electrical signal.
